(19) United States
(12) Patent Application Publication
(10) Pub. No.: US 2026/0094041 A1
(43) Pub. Date: Apr. 2, 2026

(54) QUANTUM COMPUTING SYSTEM MODEL TRAINING

(71) Applicant: Fujitsu Limited, Kawasaki-shi (JP)

(72) Inventors: Hannes LEIPOLD, San Francisco, CA (US); Steven KORDONOWY, Minnetonka, MN (US)

(73) Assignee: Fujitsu Limited, Kawasaki-shi (JP)

(21) Appl. No.: 18/901,112

(22) Filed: Sep. 30, 2024

(51) Int. Cl. G06N 10/60; G06N 10/20; G06N 10/40

(52) U.S. Cl. CPC G06N 10/60; G06N 10/20; G06N 10/40

(57) ABSTRACT

A method may include obtaining a first quantum gate set ansatz configured to perform a first task. The method may also include generating a second quantum gate set ansatz using the first quantum gate set ansatz, wherein the second quantum gate set ansatz is configured to perform a second task related to the first task. The method may include training parameters of the second quantum gate set ansatz using a first dataset. The training including adjusting electromagnetic waves applied to qubits of quantum hardware according to the second quantum gate set ansatz and the first dataset. The method may further include initializing parameters of the first quantum gate set ansatz based on the trained parameters of the second quantum gate set ansatz. The method may include training the parameters of the first quantum gate set ansatz using a second dataset related to the first dataset.

### FIELD

The present disclosure generally relates to quantum computing system model training.

### BACKGROUND

Quantum computers may use quantum bits (“qubits”) capable of representing information as ones, zeroes, or ones and zeroes simultaneously on quantum gates to perform quantum computing operations. Quantum computers may train parameters of quantum computing system models to more efficiently and/or more accurately perform some types of quantum computing operations (e.g., optimizations, graph partitioning, quadratic programming, etc.) than classical computers.

The subject matter claimed in the present disclosure is not limited to embodiments that solve any disadvantages or that operate only in environments such as those described above. Rather, this background is only provided to illustrate example technology areas where some embodiments described in the present disclosure may be practiced.

### SUMMARY

According to an aspect of an embodiment, a method may include obtaining a first quantum gate set ansatz configured to perform a first task. A second quantum gate set ansatz may be generated using the first quantum gate set ansatz. The second quantum gate set ansatz may be configured to perform a second task related to the first task. Parameters of the second quantum gate set ansatz may be trained using a first dataset. The training including adjusting electromagnetic waves applied to qubits of quantum hardware according to the second quantum gate set ansatz and the first dataset. Parameters of the first quantum gate set ansatz may be initialized based on the trained parameters of the second quantum gate set ansatz. The parameters of the first quantum gate set ansatz may be trained using a second dataset related to the first dataset. The training including adjusting electromagnetic waves applied to qubits of quantum hardware according to the first quantum gate set ansatz and the second dataset. The trained parameters used to adjust qubits of quantum hardware used to generate an output.

The objects and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example operational flow of a quantum computing system;

FIG. 2 illustrates an example environment related to training quantum computing model parameters;

FIG. 3A illustrates an example quantum gate set ansatz;

FIG. 3B illustrates another example quantum gate set ansatz;

FIG. 4 illustrates a flowchart of an example method to train quantum computing model parameters; and

FIG. 5 illustrates a block diagram of an example computing system, all in accordance with one or more embodiments of the present disclosure.

### DETAILED DESCRIPTION

Quantum computers use quantum bits, or “qubits,” which may be configured to store values of 0, 1, or a superposition of both 0 and 1. Since qubits are capable of simultaneously storing multiple values/existing in multiple states, quantum computers may be capable of performing calculations more quickly and/or more accurately than classical computers that only use classical bits capable of storing values of either 0 or 1. As a result, quantum computers may more efficiently train quantum computing system models related to advanced computations and/or may improve computations in various technology fields such as physics, chemistry, finance, and machine learning (ML).

Training quantum computing system models may be difficult or impractical because the parameter search space may expand exponentially as the number of qubits included in a quantum computer increases. For example, training quantum computing system models to perform optimization tasks, may be inefficient (e.g., unable to be solved in polynomial time). Additionally or alternatively, quantum computing system model training may suffer from the barren plateau phenomenon where the size of gradients over the parameter landscape vanish exponentially. Quantum computing system model training may also suffer from the local minima/maxima trap that are mistakenly categorized as a global minimum/maximum during the gradient descent. Therefore, it may be beneficial to train quantum computing system models with higher quality (e.g., non-zero and/or non-random) initial parameters (e.g., providing a “warm start”). Warm starting may improve the computing capabilities of quantum computers by enabling faster convergence to one or more solutions and/or reducing the likelihood of training being trapped in a suboptimal solution space.

Some embodiments of the present disclosure may describe a system and/or method to train quantum computing system model parameters. For example, the disclosure may describe a method to obtain initial values for one or more parameters for a quantum computing system model. In these and other embodiments, the initial values of the quantum computing system model may be obtained through training a simplified version of the quantum computing system model. For example, a quantum computing system model may include a quantum gate set ansatz. The quantum gate set ansatz may include a configuration of quantum gates that may be used to generate the quantum computing system models. In these and other embodiments, a simplified version of the quantum gate set ansatz, such as a subset of the quantum gate set ansatz, may be obtained. Parameters may be trained using the simplified quantum gate set ansatz. The values of the parameters trained using the simplified quantum gate set ansatz may be used to initialize the values of the parameters for the original quantum gate set ansatz for training of the quantum computing system model. Using the initialized values, a time and/or resources used to train of the quantum computing system models may be reduced and/or better parameters may be generated for the quantum computing system model. As a result, computing processes and performance of the quantum computer may be improved by creating a method and system of more efficiently and/or accurately training quantum computing system model parameters according to the present disclosure.

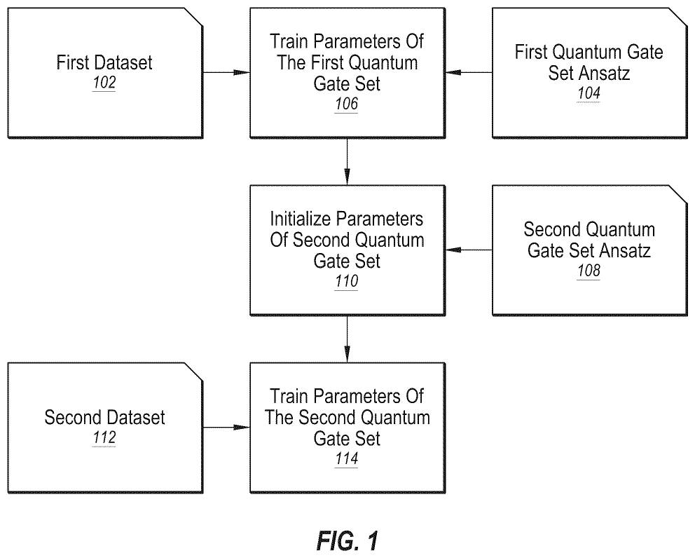

Embodiments of the present disclosure are explained with reference to the accompanying figures. FIG. 1 illustrates an example operational flow 100 of a quantum computing system according to one or more embodiments of the present disclosure. The operational flow 100 may be configured to train quantum computing model parameters.

In general, a quantum computing system may operate to perform quantum computations using a series of quantum gates that operate on quantum bits, e.g., qubits, of the quantum computing system. In general, quantum gates are configured to manipulate the quantum states of qubits. The quantum states of a qubit may include a basic state, a superposition state that may be represented by any point on a surface of a sphere where two opposite points on the sphere represent the basis states of 1 and 0 of the qubit, and a entangled state where the qubit state is based on the state of another qubit. The quantum states of the qubit may be adjusted. For example, a quantum gate may adjust the superposition state of the qubit by rotating the state of the qubit from a first position to a second position. In these and other embodiments, a quantum gate may represent an operation that may be performed on a qubit. As such, the quantum gate may be implemented by controlling quantum hardware that encodes qubits, such as by manipulating the energy levels of atoms, ions, photons, or superconducting circuits that form the quantum hardware. In these and other embodiments, the quantum hardware may be controlled by application of electromagnetic waves, such as b laser, microwaves, or other electromagnetic waves.

In these and other embodiments, how a quantum gate adjusts a qubit may be determined based on a value of a parameters of the quantum gate. For example, a gate may be configured to adjust the superposition of a qubit. In this example, a parameter of the gate may indicate the operator to be applied by the gate to the qubit, such as an angle of rotation of the qubit. As another example, a gate may be configured to adjust the strength of entanglement of one qubit with another qubit. Thus, each of the quantum gates may have one or more separate parameters that may be adjusted. The different parameters of a quantum gate may be implemented by adjusting one or more property of an electromagnetic wave that is applied to the quantum hardware. For example, an amplitude, pulse shape, duration, wavelength, or phase or other property of an electromagnetic wave may be set at a particular setting to achieve a different parameter of a quantum gate. For example, to rotate a qubit around a particular idealized axis a particular amount, such as 45 degrees, a microwave pulse with a particular duration may be applied to the qubit. In these and other embodiments, other properties of the microwave pulse may be set at a particular setting to help achieve the correct adjustment of the qubit. Thus, to adjust a parameter of a quantum gate, a property of an electromagnetic wave that may be applied to quantum hardware may be adjusted.

The quantum gates may be organized in a specific manner to implement a quantum algorithm. For example, a quantum algorithm may be written to perform a specific task. For example, a task may be a quantum Fourier transform or optimization problem, such as how to select stocks to form a portfolio that achieves a desired gain and risk tolerance. The optimization problem may be encoded into a quantum algorithm. The quantum algorithm may be represented by a specific set of quantum gates organized in a specific manner that encodes variables and operations of the quantum algorithm into a sequence of quantum gates. A set of quantum gates organized in a specific sequence may be referred to in this disclosure as a quantum gate set ansatz.

The quantum gate set ansatz may include quantum gates for solving the optimization problem. However, the quantum gate set ansatz may not include values for the parameters of the quantum gates in the quantum gate set ansatz. Selection of a specific parameter values for each of the quantum gates in the quantum gate set ansatz may be achieved by training of the parameters. Training of the parameters may include iteratively adjusting the parameters of the gates using classical optimization technique. Generally, before training none of the parameters for the quantum gates may be known. As such, each of the parameters may be initialized at zero or some random number. During training, values from a data set may be provided to the quantum gates and an outcome generated. The generated outcome may be compared to a known outcome for the values. Based on a difference between the generated outcome and the known outcome the values of the parameters may be adjusted or updated. Updating the parameters may result in one or more properties of the electromagnetic wavelengths applied to qubits of quantum hardware to generate the outcome being adjusted. For example, based on known gradient or gradient-free methods, the parameters may be updated to minimize or maximize a value computed from the generated outputs. Training may continue until the difference between the generated outcome and the known outcome are within a particular threshold or some other outcome results, such as a limit on a number of iterations or processing time.

As discussed previously, training parameters for a quantum gate set ansatz with all the parameters initialized at zero or a random number may be difficult. In some embodiments, the operational flow 100 may be configured to train parameters. In these and other embodiments, the operational flow 100 may be configured to train the parameters in two stages. For example, the parameters may be trained in a first stage using a first quantum gate set ansatz. After training the parameters in the first stage, the values of the parameters from the first stage may be used as initial values in a second stage. The training during the second stage may be accomplished using a second quantum gate set ansatz. In these and other embodiments, the first quantum gate set ansatz may be a subset of the second quantum gate set ansatz.

With respect to FIG. 1, the operational flow 100 may include a first quantum gate set ansatz 104 and a second quantum gate set ansatz 108. In some embodiments, the first quantum gate set ansatz 104 may be a subset of the second quantum gate set ansatz 108. The first quantum gate set ansatz 104 being a subset of the second quantum gate set ansatz 108 may indicate that the quantum gates of the first quantum gate set ansatz 104 may be included in the second quantum gate set ansatz 108. Alternately or additionally, the first quantum gate set ansatz 104 being a subset of the second quantum gate set ansatz 108 may indicate that the quantum gates and the configuration of the quantum gates in the first quantum gate set ansatz 104 match the quantum gates and the configuration in the second quantum gate set ansatz 108.

In some embodiments, the second quantum gate set ansatz 108 may correspond to a quantum algorithm. For example, the second quantum gate set ansatz 108 may correspond to a quantum optimization algorithm. In these and other embodiments, the first quantum gate set ansatz 104 may correspond to a portion of the quantum algorithm. For example, the quantum algorithm may include multiple terms. In these and other embodiments, the second quantum gate set ansatz 108 may represent all the terms in the quantum algorithm and the first quantum gate set ansatz 104 may represent some of the terms in the quantum algorithm.

In some embodiments, the second quantum gate set ansatz 108 may represent a quantum algorithm that includes one or more quadratics and linear terms. For example, the one or more quadratics and linear terms may be associated with applying idealized z-axis, x-axis, or y-axis rotations on single qubits or coupled x-axis, y-axis, or z-axis rotations on pairs of qubits respectfully. In these and other embodiments, the second quantum gate set ansatz 108 may represent all the terms of the quantum algorithm and the first quantum gate set ansatz 104 may represent the linear terms of the quantum algorithm for specified rotations. For example, the first quantum gate set ansatz 104 may represent only the linear terms of the quantum algorithm for specified rotations. For example, phase-separating gates applying idealized z-axis rotations and coupled z-axis rotations on pairs of qubits may not be included in the first quantum gate set ansatz 104 while rotation gates associated with mixing that involve x-axis and y-axis rotations as well as multi-qubit coupled x-axis and y-axis rotations may be included in the first quantum gate set ansatz 104. As another example, the quadratics terms of the quantum algorithm may not be represented by the first quantum gate set ansatz 104 such that using solving with a quantum algorithm with quadratics terms in the measurements using the first quantum gate set ansatz 104 may not account for the quadratics terms for the quantum algorithm.

In some embodiments, the first quantum gate set ansatz 104 may be generated from the second quantum gate set ansatz 108. For example, one or more quantum gates may be removed from the second quantum gate set ansatz 108 to generate the first quantum gate set ansatz 104. In some embodiments, the second quantum gate set ansatz 108 may satisfy properties of being generators of a specific Lie algebra. In these and other embodiments, the first quantum gate set ansatz 104 after being generated from the second quantum gate set ansatz 108 may also satisfy properties being generators of a Lie algebra.

In some embodiments, the one or more quantum gates that are removed from the second quantum gate set ansatz 108 may correspond to one or more quadratic terms of the quantum algorithm. The one or more quantum gates that correspond to the one or more quadratic terms may the quantum gates that may represent the quadratic terms and used to solve the quadratic terms in the quantum algorithm. As a result, the first quantum gate set ansatz 104 may represent the quantum algorithm as if a variable of one or more quadratic terms is set to zero. When the quantum algorithm is an optimization algorithm, the variable may correspond to a bounding coefficient.

With the first quantum gate set ansatz 104 being generated from the second quantum gate set ansatz 108, the first quantum gate set ansatz 104 may be a simplified version of the second quantum gate set ansatz 108. In these and other embodiments, the first quantum gate set ansatz 104 being a simplified version may include the first quantum gate set ansatz 104 including fewer quantum gates than the second quantum gate set ansatz 108. As such, there may be fewer parameters of quantum gates to adjust when training quantum gate parameters using the first quantum gate set ansatz 104 as compared to training quantum gate parameters using the second quantum gate set ansatz 108.

In some embodiments, the operational flow 100 may train quantum gate parameters using datasets related to the quantum problem to be solved. For example, the operational flow 100 may obtain a first dataset 102 and a second dataset 112 for using in training quantum gate parameters. In some embodiments, the first dataset 102 may include data that may be used to train quantum gate parameters of the first quantum gate set ansatz 104. Alternately or additionally, the second dataset 112 may include data that may be used to train quantum gate parameters of the second quantum gate set ansatz 108.

In some embodiments, the first dataset 102 and/or the second dataset 112 may include a single set of data or multiple sets of data. In some embodiments, the first dataset 102 and/or the second dataset 112 may include a compilation of data that may include multiple different data entries and may be arranged in multiple different configurations. In some embodiments, the first dataset 102 and/or the second dataset 112 may include data from or that represents financial/business data, statistical metrics, biological/medical/pharmacological data, technological data, and/or any other type of data. In some embodiments, the first dataset 102 and/or the second dataset 112 may be input by a user, generated by a computing device (e.g., a quantum computing device, a classical computing device, etc.), obtained (e.g., downloaded) from a network, and/or generated by a device such as a sensor, camera, satellite, bioinformatic device, healthcare device, audio device, video device, and/or any other device, or combinations thereof. In some embodiments, the second dataset 112 may include multiple features (e.g., stock name/identifier, date of investment, historical/expected return rate, covariance, etc.).

In some embodiments, the second dataset 112 and the first dataset 102 may be related. For example, the first dataset 102 may be a subset of the data included in the second dataset 112 (e.g., the first dataset 102 may exclude data corresponding to one or more features included in the second dataset 112). In these and other embodiments, the second dataset 112 may include more features than the first dataset 102. In these and other embodiments, the features included in the second dataset 112 and not included in the first dataset 102 may correspond to the quantum gates included in the second quantum gate set ansatz 108 and not included in the first quantum gate set ansatz 104.

For example, the first dataset 102 and/or the second dataset 112 may include data relating to financial investments such as the financial returns from a particular asset or from multiple different assets in a financial portfolio. In some embodiments, the dataset of financial returns may relate to linear terms of the quantum algorithm. In some embodiments, the second dataset 112 may also include covariance data relating to financial investments. The covariance data may relate to quadratic terms of the quantum algorithm that may be expressed in the second quantum gate set ansatz 108 and not in the first quantum gate set ansatz 104. In these and other embodiments, the first dataset 102 may not include the covariance data because the first quantum gate set ansatz 104 may not include quantum gates that are configured to be trained using the covariance data. Not including quantum gates that are configured to be trained using the covariance data may have a dramatic impact on the associated Lie Algebra and its mathematical properties, such as the dimensions associated with Lie Algebra, since the gate set has changed.

The operational flow 100 may being with a training operation 106. The training operation 106 may include training quantum gate parameters of the quantum gates of the first quantum gate set ansatz 104, referred to in this disclosure as training the first quantum gate set ansatz 104. To begin, the parameters may be initialized. In these and other embodiments, the parameters may be initialized to zero, random numbers, or some other number. Initialization of the parameters may set the specific properties of the electromagnetic wavelengths that may be used to interact with the qubits. After initialization, the first quantum gate set ansatz 104 may be trained using the first dataset 102. For example, data from the first dataset 102 may be provided to the first quantum gate set ansatz 104 and an output may be generated. The generated output may be compared to a known output. A difference between the known output and the generated output may be used to adjust the parameters of the first quantum gate set ansatz 104. Adjusting the parameters of the first quantum gate set ansatz 104 may include adjusting the properties of the electromagnetic waves applied to qubits of quantum hardware.

In some embodiments, a gradient or non-gradient method, among other methods, may be used to adjust the parameters of the second quantum gate set ansatz 104 to attempt to minimize or maximize a value computed from the generated output. Other data may be provided to the first quantum gate set ansatz 104 and the training may continue. In the continued training, the adjusted electromagnetic waves may be applied to the qubits of the quantum hardware to change the states of the qubits and thereby change the output generated by the qubits in response to the first dataset 102. In these and other embodiments, multiple iterations of training using the full first dataset 102 or a portion of the first dataset 102 may occur. Any amount of training may be considered within the scope of this disclosure. After training the first quantum gate set ansatz 104 using the first dataset 102, the parameters of the first quantum gate set ansatz 104 may include specific trained values. As such, in some embodiments, each parameter for each quantum gate in the first quantum gate set ansatz 104 may include a specific trained value.

The operational flow 100 may further include an initialization operation 110. In the initialization operation 110, the parameters of the second quantum gate set ansatz 108 may be initialized. In these and other embodiments, one or more of the specific trained values from the first quantum gate set ansatz 104 may be used to initial values for parameters of the quantum gates of the second quantum gate set ansatz 108. To initialize the parameters of the second quantum gate set ansatz 108, common gates between the first quantum gate set ansatz 104 and the second quantum gate set ansatz 108 may be identified. For example, a quantum gate that is the same type of quantum gate and in a same location in the quantum gate set of the first quantum gate set ansatz 104 and the second quantum gate set ansatz 108 may be considered common gates. In these and other embodiments, the specific trained values of the quantum gates of the first quantum gate set ansatz 104 may be used as initialization value for the quantum gates of the second quantum gate set ansatz 108 that are common gates. For example, gates F1 and F2 of the first quantum gate set ansatz 104 may be common to gates S1 and S2, respectively, of the second quantum gate set ansatz 108. In these and other embodiments, the specific trained values of gate F1 may be used as an initial parameter value of gate S1 and the specific trained values of gate F2 may be used as an initial parameter value of gate S2. In these and other embodiments, all or only a part of the specific trained values of the quantum gates of the first quantum gate set ansatz 104 may be used as initial parameter values for the quantum gates of the second quantum gate set ansatz 108.

In some embodiments, the other quantum gates that are included in the second quantum gate set ansatz 108 but not included in the first quantum gate set ansatz 104 may be initialized to other values. For example, the other quantum gates may be initialized to zero, a random number, or some other number.

The operational flow 100 may proceed with a training operation 114. The training operation 114 may include training quantum gate parameters of the quantum gates of the second quantum gate set ansatz 108, referred to in this disclosure as training the second quantum gate set ansatz 108. The second quantum gate set ansatz 108 may be trained using the second dataset 112. For example, data from the second dataset 112 may be provided to the second quantum gate set ansatz 108 and an output may be generated. The generated output may be compared to a known output. A difference between the known output and the generated output may be used to adjust the parameters of the second quantum gate set ansatz 108. Adjusting the parameters of the first quantum gate set ansatz 104 may include adjusting the properties of the electromagnetic waves applied to the qubits of the quantum hardware. In some embodiments, a gradient or non-gradient method, among other methods, may be used to adjust the parameters of the second quantum gate set ansatz 108 to attempt to minimize or maximize a value computed from the generated output. Other data may be provided to the second quantum gate set ansatz 108 and the training may continue. In these and other embodiments, multiple iterations of training using the full second dataset 112 or a portion of the second dataset 112 may occur. Any amount of training may be considered within the scope of this disclosure.

After training the second quantum gate set ansatz 108 using the second dataset 112, the parameters of the second quantum gate set ansatz 108 may include specific trained values. As such, each parameter for each quantum gate in the second quantum gate set ansatz 108 may include a specific trained value. Note that the parameters set in the initialization operation 110 may not remain static. Rather, the parameters set in the initialization operation 110 of the second quantum gate set ansatz 108 may be further adjusted and refined during the training operation 114. However, by initializing some of the parameters of the second quantum gate set ansatz 108, the training operation 114 may be simplified. For example, a training time, duration, or processing power may be reduced. Furthermore, the training operation 114 may be simplified to such a degree that the time to perform the operational flow 100 may be less than a time to perform training of the second quantum gate set ansatz 108 without performing the operational flow 100 that includes initializing parameters of the second quantum gate set ansatz 108 with the values from the first quantum gate set ansatz 104 after training. Alternately or additionally, by initializing some of the parameters of the second quantum gate set ansatz 108, the training operation 114 may achieve a better result.

Modifications, additions, or omissions may be made to the operational flow 100 without departing from the scope of the disclosure. For example, the designations of different elements in the manner described is meant to help explain concepts described herein and is not limiting. For instance, in some embodiments, the operational flow 100 may be delineated in the specific manner described to help with explaining concepts described herein, but such delineation is not meant to be limiting. Further, the operational flow 100 may include any number of other elements or may be implemented within other systems or contexts than those described.

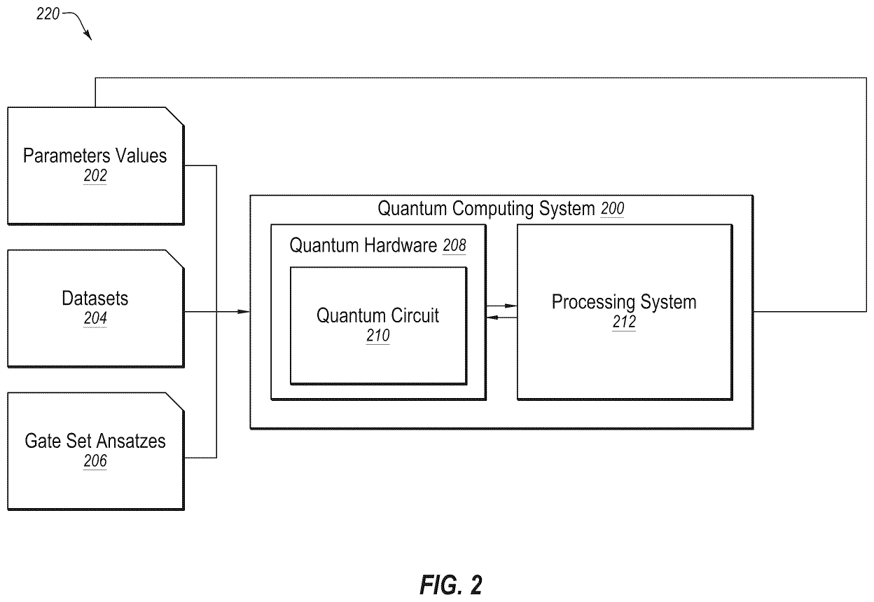

FIG. 2 illustrates an example environment 220 related to training quantum computing system model parameters. The environment 220 may include a quantum computing system 200, parameter values 202, datasets 204, and gate set ansatzes 206. The quantum computing system 200 may be configured to take the parameter values 202, the datasets 204, the gate set ansatzes 206 as inputs and to update one or more of the parameter values 202 with specific trained values.

The gate set ansatzes 206 may include a first gate set ansatz and a second gate set ansatz. The first and the second gate set ansatzes may be analogous to the first quantum gate set ansatz 104 and the second quantum gate set ansatz 108, respectively, of FIG. 1. As such no further description is provided with respect to FIG. 2. The datasets 204 may include a first data set and a second data set. The first data set may correspond to the first gate set ansatz and the second data set may correspond to the second gate set ansatz. The correspondence between a data set and a gate set ansatz may indicate that data set includes features that are represented in the gate set ansatz. For example, because the second gate set ansatz includes additional quantum gates, the second dataset may include additional features that correspond to the additional quantum gates. The first data set and the second data set may be analogous to the first dataset 102 and the second dataset 112, respectively, of FIG. 1. As such no further description is provided with respect to FIG. 2.

The parameters values 202 may be initialization values for parameters of the quantum gates of the gate set ansatzes 206. In an initial condition, the parameter values may be set to zero, random numbers, or other numbers.

In some embodiments, the quantum computing system 200 may include quantum hardware 208. For example, the quantum hardware 208 may include a quantum processor that includes one or more qubits and an ability to store the qubits. In some embodiments, the qubits may be physically implemented using, for example, photons, trapped ions, electrons, one or more nuclei, superconductor circuits, and/or quantum dots. For example, the qubits may be physically implemented in a variety of ways including the polarization state of a single photon, the spatial optical path of a single photon, two differing energy states of an atom or an ion, and/or the spin orientation of a particle or multiple particles, such as a nucleus. In some embodiments, the quantum processor may comprise at least two qubits and at least one coupler capable of coupling the qubits. Storing the qubits may include maintaining the qubits in a suitable environment to allow quantum computation, for example by supercooling the qubits.

In some embodiments, the quantum hardware 208 may include a quantum circuit 210. The quantum circuit 210 may be formed by a suitable arrangement of quantum gates and may operate on the qubits included in the quantum hardware 208. In some embodiments, quantum gates of the quantum circuit 210 may be configured according to one of the gate set ansatzes 206. For example, during a first period, the quantum circuit 210 may be configured according to a first gate set ansatz of the gate set ansatzes 206. During a second period, the quantum circuit 210 may be configured according to a second gate set ansatz of the gate set ansatzes 206. The quantum circuit 210 may determine properties of electromagnetic waves that may be applied to the qubits of the quantum hardware 208 to adjust the states of the qubits.

In some embodiments, the parameters of the quantum gates of the quantum circuit 210 may be initialized with values from the parameter values 202. To begin, the parameter values 202 may be set to zero, random numbers, or some other selected values. After processing, the quantum computing system 200 may be configured to update one or more of the parameter values 202. For example, the quantum computing system 200 may update one or more of the parameter values 202 with specific trained values based on computation performed by the quantum computing system 200. Updating the values may include updating properties of electromagnetic waves that may be applied to the qubits of the quantum hardware 208 to adjust the states of the qubits.

The processing system 212 may be any configuration of non-quantum processing devices and/or system. For example, the processing system 212 may include one or more elements of the computing system 500. In these and other embodiments, the processing system 212 may be configured to control the quantum hardware 208, provide data to the quantum hardware 208, obtain data from the quantum hardware 208, and/or otherwise interact with the quantum hardware 208 to assist the quantum hardware 208 in performing the functionality of the quantum hardware 208.

In some embodiments, the parameter values 202, the datasets 204, and/or the gate set ansatzes 206 may be obtained/provided to the quantum computing system 200 via one or more physical networks, cloud networks, Random Access Memory (RAM) drives, flash memory devices (e.g., solid state memory devices), and/or any other way by which data may be transferred between devices and/or systems.

An example of the operation of the quantum computing system 200 is now provided. The quantum circuit 210 may be configured according to the first gate set ansatz. The parameters of the first gate set ansatz may be initialized using the parameter values 202 that correspond to the quantum gates in the first gate set ansatz. The quantum hardware 208 may perform one or more operations using a first data set of the datasets 204 to train the parameters of the first gate set ansatz. Training the parameters may include adjusting properties of electromagnetic waves that may be applied to the qubits of the quantum hardware 208 to adjust the states of the qubits. The training of the parameters of the first gate set ansatz may result in specific trained values for one or more parameters of one or more quantum gates of the first gate set ansatz. In these and other embodiments, the quantum computing system 200 may update the parameter values 202 for the one or more quantum gates with the specific trained values.

After performing the operations with respect to the first gate set ansatz, the quantum circuit 210 may be configured according to the second gate set ansatz. The parameters of the second gate set ansatz may be initialized using the parameter values 202 that correspond to the quantum gates of the second gate set ansatz. Note that some of the parameter values used to initial some of the quantum gates of the second gate set ansatz may be the specific trained values. In these and other embodiments, the quantum hardware 208 may perform one or more operations using second dataset to train the parameters of the second gate set ansatz. Training the parameters may include adjusting properties of electromagnetic waves that may be applied to the qubits of the quantum hardware 208 to adjust the states of the qubits. The training of the parameters of the second gate set ansatz may result in specific trained values for one or more parameters of one or more quantum gates of the second gate set ansatz. The specific trained values of the second gate set ansatz may be used as model parameters for a quantum algorithm that is expressed in part or in whole by the gate set ansatzes 206. Using the model parameters, the specific properties of the electromagnetic waves may be known that may be used to adjust qubits of the quantum hardware 208 to place the qubits in the correct state to generate a desired output.

After training using the second gate set ansatz, data may be provided to the quantum hardware 208 and processed to generate an output. To process the data, the states of the qubits may be set using the electromagnetic waves with the specific properties. The output may be a solution for the quantum algorithm given the data provided to the quantum hardware 208.

Modifications, additions, or omissions may be made to the environment 220 without departing from the scope of the disclosure. For example, the quantum computing system 200 may include one or more additional components. Alternately or additionally, the quantum computing system 200 may not include the processing system 212. In these and other embodiments, the processing system 212 may be separate from and networked with the quantum computing system 200. Alternately or additionally, the environment 220 may include one or more additional components.

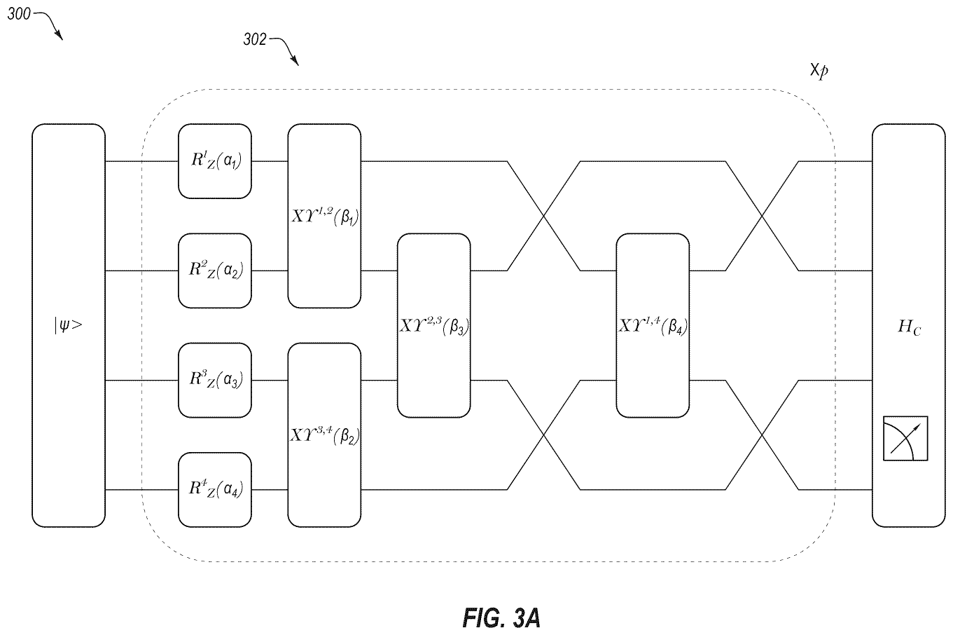

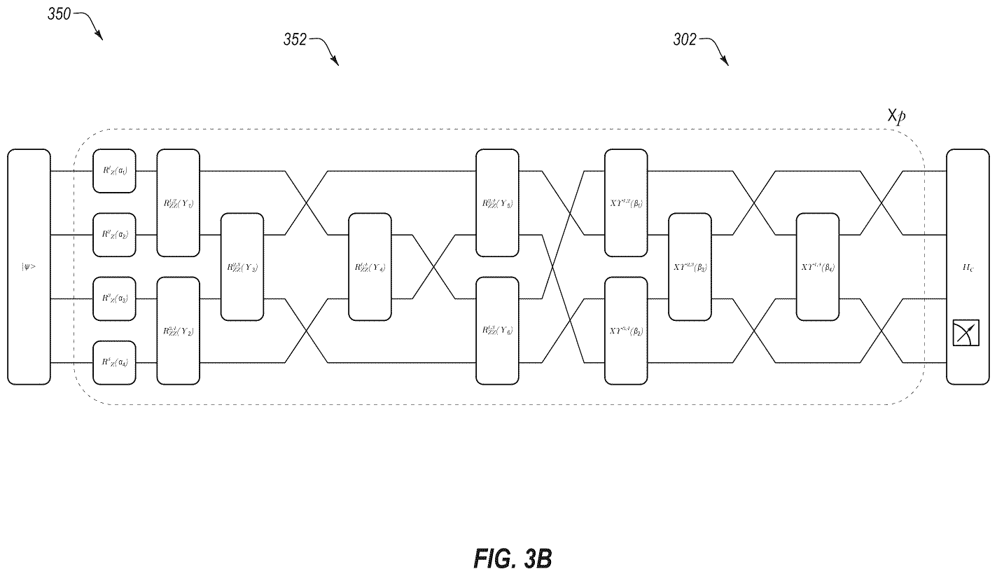

FIG. 3A illustrates an example quantum gate set ansatz 300. The quantum gate set ansatz 300 may be an example of the first quantum gate set ansatz 104 of FIG. 1. The quantum gate set ansatz 300 may include first quantum gates 302. The first quantum gates 302 may include a first arrangement as illustrated. The first quantum gates 302 may include rotational gates R_{z} and XY gates.

FIG. 3B illustrates an example quantum gate set ansatz 350. The quantum gate set ansatz 350 may be an example of the second quantum gate set ansatz 108 of FIG. 1. The quantum gate set ansatz 350 may include the first quantum gates 302 as illustrated in FIG. 3A and may include second quantum gates 352. The second quantum gates 352 may include a second arrangement as illustrated and may connect to the first quantum gates 302. The second quantum gates 352 may include Ising gates R_{zz}.

Note that the quantum gate set ansatz 300 is a subset of the quantum gate set ansatz 350. For example, each of the quantum gates in the quantum gate set ansatz 300 is included in the quantum gate set ansatz 350. Furthermore, the configuration, e.g., the interconnections between the quantum gates of the quantum gate set ansatz 300 may be the same or similar as the interconnections between the quantum gates of the quantum gate set ansatz 350.

As illustrated, the quantum gates of the quantum gate set ansatz 300 are not continuous in the configuration of the quantum gate set ansatz 350. For example, the rotational R gates of the quantum gate set ansatz 300 are not directly coupled to the XY gates of the quantum gate set ansatz 300 in the quantum gate set ansatz 350. Instead, the Ising gates R_{zz} are located between the rotational R gates and the XY gates. Note that the connections between the rotational R gates and the XY gates between the quantum gate set ansatz 350 and the quantum gate set ansatz 350 are maintained even though the Ising gates R_{zz} are removed. Thus, the quantum gate set ansatz 300, e.g., the subset ansatz, may not be a continuous grouping of quantum gates from the quantum gate set ansatz 350. Rather, the subset ansatz, e.g., the quantum gate set ansatz 300, may be constructed from the original ansatz, e.g., the quantum gate set ansatz 350, by removing one or more continuous portions of quantum gates from the quantum gate set ansatz 350. For example, the continuous portions may be at the beginning, in the middle, or at the end of the original ansatz.

Modifications, additions, or omissions may be made to the quantum gate set ansatz 300 and the quantum gate set ansatz 350 without departing from the scope of the disclosure. For example, one or more gates may be added or removed from the quantum gate set ansatz 300 and the quantum gate set ansatz 350.

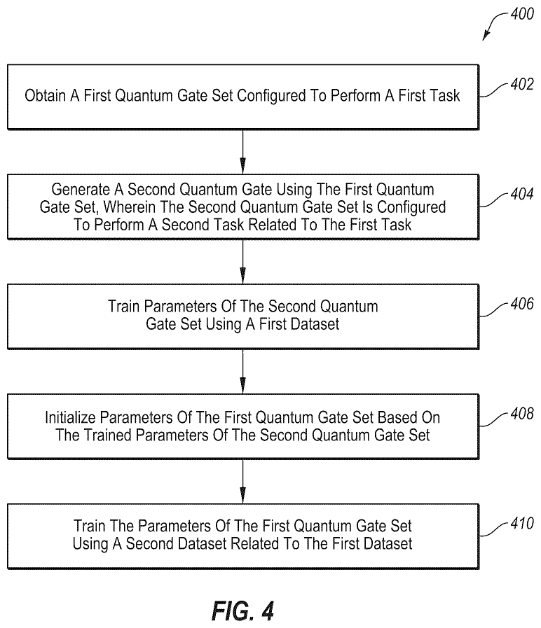

FIG. 4 is a flowchart of an example method 400 of training quantum computing system model parameters using a restricted quantum gate set on a quantum computer, according to one or more embodiments of the present disclosure. The method 400 may be performed by any suitable system, apparatus, or device. For example, the quantum computing system 200, the quantum hardware 208, and/or the processing system 212 may perform one or more of the operations associated with the method 400. Although illustrated with discrete blocks, the steps and operations associated with one or more of the blocks of the method 400 may be divided into additional blocks, combined into fewer blocks, or eliminated, depending on the particular implementation.

The method 400 may begin at block 402, where a first quantum gate set ansatz configured to perform a first task may be obtained.

At block 404, a second quantum gate set ansatz may be generated using the first quantum gate set ansatz. In these and other embodiments, the second quantum gate set ansatz may be configured to perform a second task related to the first task.

In some embodiments, generating the second quantum gate set ansatz may include removing one or more quantum gates included in the first quantum gate set ansatz. In these and other embodiments, both the first quantum gate set ansatz and the second quantum gate set ansatz may satisfy properties of generators of a Lie algebra.

In some embodiments, the one or more quantum gates that are removed may be used in solving one or more quadratic terms in a quantum algorithm on which the first quantum gate set ansatz is based. In these and other embodiments, the removal of the one or more quantum gates may result in setting a variable of the one or more quadratic terms in the quantum algorithm to zero. In some embodiments, the variable is a bounding coefficient.

In some embodiments, the second quantum gate set ansatz may include quantum gates that are used to solve one or more linear terms in a quantum algorithm on which the first quantum gate set ansatz is based. In these and other embodiments, the quantum algorithm may be a quantum optimization algorithm.

At block 406, parameters of the second quantum gate set ansatz may be trained using a first dataset. The second quantum gate set ansatz may be trained using quantum hardware. In some embodiments, the first dataset may include financial return data corresponding to financial assets. In some embodiments, the training including adjusting electromagnetic waves applied to qubits of quantum hardware according to the second quantum gate set ansatz and the first dataset.

At block 408, parameters of the first quantum gate set ansatz may be initialized based on the trained parameters of the second quantum gate set ansatz. In some embodiments, initializing the parameters of the first quantum gate set ansatz may include identifying common quantum gates between the first quantum gate set ansatz and the second quantum gate set ansatz and setting the parameters of the first quantum gate set ansatz to the trained parameters of the second quantum gate set ansatz for the identified common quantum gates. In these and other embodiments, the initializing may further include setting remaining parameters of the first quantum gate set ansatz to zero.

At block 410, the parameters of the first quantum gate set ansatz may be trained using a second dataset related to the first dataset. The second quantum gate set ansatz may be trained using quantum hardware. In some embodiments, the training including adjusting electromagnetic waves applied to qubits of quantum hardware according to the first quantum gate set ansatz and the second dataset. In some embodiments, the trained parameters may be used to configured quantum hardware to generate a desired output with other data.

In some embodiments, the second dataset may include covariance data corresponding to the financial return data of the first data set. In these and other embodiments, the first task and the second task may each include a task of identifying a set of the financial assets.

Modifications, additions, or omissions may be made to the method 400 without departing from the scope of the disclosure. For example, the designations of different elements in the manner described is meant to help explain concepts described herein and is not limiting. Further, the method 400 may include any number of other elements or may be implemented within other systems or contexts than those described.

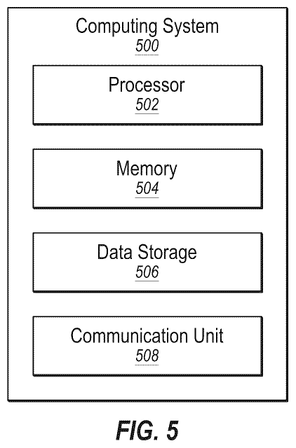

FIG. 5 is an example computing system 500 according to one or more embodiments of the present disclosure. The computing system 500 may include a processor 502, a memory 504, a data storage 506, and/or a communication unit 508, which all may be communicatively coupled. For example, the processing system 212 of FIG. 2 may include one or more components of the computing system 500.

Generally, the processor 502 may include any suitable special-purpose or general-purpose computer, computing entity, or processing device including various computer hardware or software modules and may be configured to execute instructions stored on any applicable computer-readable storage media. For example, the processor 502 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 5, it is understood that the processor 502 may include any number of processors distributed across any number of network or physical locations that are configured to perform individually or collectively any number of operations described in the present disclosure. In some embodiments, the processor 502 may interpret and/or execute program instructions and/or process data stored in the memory 504, the data storage 506, or the memory 504 and the data storage 506. In some embodiments, the processor 502 may fetch program instructions from the data storage 506 and load the program instructions into the memory 504.

After the program instructions are loaded into the memory 504, the processor 502 may execute the program instructions, such as instructions to cause the computing system 500 to perform some of the operations of the method 400 of FIG. 4. For example, the computing system 500 may execute the program instructions to generate a second quantum gate set ansatz using the first quantum gate set ansatz.

The memory 504 and the data storage 506 may include computer-readable storage media or one or more computer-readable storage mediums for having computer-executable instructions or data structures stored thereon. Such computer-readable storage media may be any available media that may be accessed by a general-purpose or special-purpose computer, such as the processor 502. In some embodiments, the computing system 500 may or may not include either of the memory 504 and the data storage 506.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 502 to perform a particular operation or group of operations.

The communication unit 508 may include any component, device, system, or combination thereof that is configured to transmit or receive information over a network. In some embodiments, the communication unit 508 may communicate with other devices at other locations, the same location, or even other components within the same system. For example, the communication unit 508 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 508 may permit data to be exchanged with a network and/or any other devices or systems described in the present disclosure. For example, the communication unit 508 may allow the computing system 500 to communicate with other systems, such as computing devices and/or other networks.

One skilled in the art, after reviewing this disclosure, may recognize that modifications, additions, or omissions may be made to the computing system 500 without departing from the scope of the present disclosure. For example, the computing system 500 may include more or fewer components than those explicitly illustrated and described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc. ” or “one or more of A, B, and C, etc. ” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B. ”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,“ “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method, comprising:
obtaining a first quantum gate set ansatz configured to perform a first task;
generating a second quantum gate set ansatz using the first quantum gate set ansatz, the second quantum gate set ansatz is configured to perform a second task related to the first task;
training parameters of the second quantum gate set ansatz using a first dataset, the training including adjusting electromagnetic waves applied to qubits of quantum hardware according to the second quantum gate set ansatz and the first dataset;
initializing parameters of the first quantum gate set ansatz based on the trained parameters of the second quantum gate set ansatz; and
training the parameters of the first quantum gate set ansatz using a second dataset related to the first dataset, the training including adjusting electromagnetic waves applied to qubits of quantum hardware according to the first quantum gate set ansatz and the second dataset, the trained parameters used to adjust qubits of quantum hardware used to generate an output.

2. The method of claim 1, wherein the generating the second quantum gate set ansatz includes removing one or more quantum gates included in the first quantum gate set ansatz.

3. The method of claim 2, wherein both the first quantum gate set ansatz and the second quantum gate set ansatz satisfy properties of Lie algebra.

4. The method of claim 2, wherein the one or more quantum gates that are removed are used in solving one or more quadratic terms in a quantum algorithm on which the first quantum gate set ansatz is based.

5. The method of claim 4, wherein the removing of the one or more quantum gates results in setting a variable of the one or more quadratic terms in the quantum algorithm to zero.

6. The method of claim 5, wherein the variable is a bounding coefficient.

7. The method of claim 2, wherein the second quantum gate set ansatz includes quantum gates that are used to solve one or more linear terms in a quantum algorithm on which the first quantum gate set ansatz is based.

8. The method of claim 7, wherein the quantum algorithm is a quantum optimization algorithm.

9. The method of claim 1, wherein the initializing the parameters of the first quantum gate set ansatz comprises:
identifying common quantum gates between the first quantum gate set ansatz and the second quantum gate set ansatz;
setting the parameters of the first quantum gate set ansatz to the trained parameters of the second quantum gate set ansatz for the identified common quantum gates; and
setting remaining parameters of the first quantum gate set ansatz to zero.

10. The method of claim 1, wherein the first dataset comprises financial return data corresponding to financial assets, the second dataset comprises covariance data corresponding to the financial return data, and the first task and the second task each include a task of identifying a set of the financial assets.

11. A system comprising:
a quantum computing system comprising:
a first quantum gate set ansatz configured to perform a first task;
a second quantum gate set ansatz generated based on the first quantum gate set ansatz, the second quantum gate set ansatz is configured to perform a second task related to the first task; and
quantum hardware, the quantum hardware configured to:
train parameters of the second quantum gate set ansatz using a first dataset, the training including adjusting electromagnetic waves applied to qubits of quantum hardware according to the second quantum gate set ansatz and the first dataset, and
train the parameters of the first quantum gate set ansatz using a second dataset related to the first dataset, the training including adjusting electromagnetic waves applied to qubits of quantum hardware according to the first quantum gate set ansatz and the second dataset, the parameters of the first quantum gate set ansatz are initialized based on the trained parameters of the second quantum gate set ansatz.

12. The system of claim 11, wherein the second quantum gate set ansatz is generated by removing one or more quantum gates included in the first quantum gate set ansatz.

13. The system of claim 12, wherein both the first quantum gate set ansatz and the second quantum gate set ansatz satisfy properties of Lie algebra.

14. The system of claim 12, wherein the one or more quantum gates that are removed are used in solving one or more quadratic terms in a quantum algorithm on which the first quantum gate set ansatz is based.

15. The system of claim 14, wherein the removing of the one or more quantum gates results in setting a variable of the one or more quadratic terms in the quantum algorithm to zero.

16. The system of claim 15, wherein the variable is a bounding coefficient.

17. The system of claim 11, wherein the second quantum gate set ansatz includes quantum gates that are used to solve one or more linear terms in a quantum algorithm on which the first quantum gate set ansatz is based.

18. The system of claim 11, wherein the quantum computing system is configured to initialize the parameters of the first quantum gate set ansatz by:
identifying common quantum gates between the first quantum gate set ansatz and the second quantum gate set ansatz;
setting the parameters of the first quantum gate set ansatz to the trained parameters of the second quantum gate set ansatz for the identified common quantum gates; and
setting remaining parameters of the first quantum gate set ansatz to zero.

19. The system of claim 11, wherein the first dataset comprises financial return data corresponding to financial assets, the second dataset comprises covariance data corresponding to the financial return data, and the first task and the second task each include a task of identifying a set of the financial assets.

20. A non-transitory computer readable media configured to store instructions that when executed by a system perform operations comprising:
obtaining a first quantum gate set ansatz configured to perform a first task;
directing generation of a second quantum gate set ansatz using the first quantum gate set ansatz, the second quantum gate set ansatz configured to perform a second task related to the first task;
directing training of parameters of the second quantum gate set ansatz using a first dataset, the training including adjusting electromagnetic waves applied to qubits of quantum hardware according to the second quantum gate set ansatz and the first dataset;
directing initialization of parameters of the first quantum gate set ansatz based on the trained parameters of the second quantum gate set ansatz; and
directing training of the parameters of the first quantum gate set ansatz using a second dataset related to the first dataset, the training including adjusting electromagnetic waves applied to qubits of quantum hardware according to the first quantum gate set ansatz and the second dataset, the trained parameters used to adjust qubits of quantum hardware used to generate an output.
